(19) United States
(12) Patent Application Publication
(10) Pub. No.: US 2010/0114649 A1
(43) Pub. Date: May 6, 2010

(54) Buffer Analysis Model For Asset Protection

(76) Inventor: Michael L. Asher, Green Cove Sp., FL (US)

Correspondence Address: AT&T Legal Department - HBH;Attn: Patent Docketing, One AT&T Way, Room 2A-207, Bedminster, NJ, 07921, US

(21) Appl. No.: 12/262,713

(22) Filed: Oct. 31, 2008

(51) Int. Cl. G06Q 10/00; G06Q 50/00

(52) U.S. Cl. 705/10; 705/7

(57) ABSTRACT

Methods, systems, and computer-readable media provide for determining an optimum buffer width for an above ground or buried asset. According to the method, a restorability measurement and a revenue measurement for the asset are determined. The restorability measurement indicates an ability for a technician to restore the asset when the asset becomes damaged. The revenue measurement indicates a value of a service provided through the asset. The optimum buffer width is determined based on the restorability measurement and the revenue measurement. The optimum buffer width includes a width of a buffer indicating an approximate location of the asset.

### BACKGROUND

Communications and utility service providers (hereinafter referred to as “service providers”) often own or maintain substantial buried assets, such as communications cables, power service cables, water pipes, gas pipes, and the like. In many cases, those planning to dig into the ground are required, or at least encouraged, to first notify the service providers prior to digging. In order to facilitate communications between the digger (e.g., a contractor) and the service providers, utility location services, commonly referred to as “one-call” and “call before you dig”, have been created. For example, a contractor may call a utility location service and inform them of a planned dig. Upon receiving the call, the utility location service notifies the service providers with buried assets at or near the planned dig. The service providers may then inform the contractor, either directly or through the utility location service, whether any buried assets are present. The service providers may also send one or more technicians to the dig site to mark locations where buried assets are present and/or to monitor the actual dig.

Each time a caller contacts the utility location service, an operator at the utility location service typically creates a ticket. As used herein, a ticket generally refers to a record containing any suitable information about a planned dig. For example, a ticket may include an identification of the caller, a date that the call was received, a date for the planned dig, and a location of the planned dig. The location of the planned dig may be identified by address, corresponding latitude and longitude coordinates, and other suitable location identifiers.

Due to the immense volume of tickets transmitted from utility location services, service providers often resolve each ticket through an automated process. At least a portion of the automated process usually includes an operation for matching the location of the planned dig against a record of existing buried exists identified by a geographic information system (“GIS”) or other suitable technology. This approach, however, is inherently unreliable due to the possibility of human error as well as the imprecise nature of the technology involved. For example, street address data can be missing or incorrect, and the location of buried assets can be incorrect within a GIS application. Even when the street address is correct, the street address may not provide much guidance as to the specific location of a dig, particularly if the address identifies a large parcel of land (e.g., in a rural area). Further, a caller may relay an incorrect dig location to the operator, or the operator may input an incorrect dig location into a computer when creating the ticket.

The inaccuracy of conventional approaches for predicting the location of buried assets with respect to a planned dig can increase the risk of asset damage. In particular, if the automated process previously described inaccurately predicts that a planned dig does not interfere with existing buried assets, then a contractor performing the dig may damage the asset during the actual excavation. In order to account for the inaccuracy of the automated process, the automated process may be adjusted to liberally (i.e., increasingly) predict that the planned dig interferes with existing buried assets. However, an incorrect prediction that the planned dig interferes with existing buried assets can result in wasted labor resources since the service provider may dispatch technicians to the dig location to mark the buried assets and/or to monitor the planned dig.

### SUMMARY

Embodiments of the disclosure presented herein include methods, systems, and computer-readable media determining an optimum buffer width for an above-ground or buried asset. According to one aspect, a method for determining an optimum buffer width for an above-ground or buried asset is provided. According to the method, a restorability measurement and a revenue measurement for the asset are determined. The restorability measurement indicates an ability for a technician to restore the asset when the asset becomes damaged. The revenue measurement indicates a value of a service provided through the asset. The optimum buffer width is determined based on the restorability measurement and the revenue measurement. The optimum buffer width includes a width of a buffer indicating an approximate location of the asset.

According to another aspect, a system for determining an optimum buffer width for an above-ground or buried asset is provided. The system includes a memory and a processor functionally coupled to the memory. The memory stores a program containing code for determining an optimum buffer width for the asset asset. The processor is responsive to computer-executable instructions contained in the program and operative to determine a restorability measurement for the asset, determine a revenue measurement for the asset, and determine the optimum buffer width based on the restorability measurement and the revenue measurement. The restorability measurement indicates an ability for a technician to restore the asset when the asset becomes damaged. The revenue measurement indicates a value of a service provided through the asset. The optimum buffer width is determined based on the restorability measurement and the revenue measurement. The optimum buffer width includes a width of a buffer indicating an approximate location of the asset.

According to yet another aspect, a computer-readable medium having instructions stored thereon for execution by a processor to perform a method for determining an optimum buffer width for an above-ground or buried asset is provided. According to the method, a restorability measurement and a revenue measurement for the asset are determined. The restorability measurement indicates an ability for a technician to restore the asset when the asset becomes damaged. The revenue measurement indicates a value of a service provided through the asset. The optimum buffer width is determined based on the restorability measurement and the revenue measurement. The optimum buffer width includes a width of a buffer indicating an approximate location of the asset.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIGS. 1A, 1B, and 1C are diagrams illustrating a buffer of varying widths with respect to a fixed dig location, in accordance with exemplary embodiments.

FIG. 2 is a diagram illustrating a ticket creation and processing data flow between a caller, a utility location service, and a service provider, in accordance with exemplary embodiments.

FIG. 3 is a flow diagram illustrating a method for determining an optimum buffer width for a buried asset, in accordance with exemplary embodiments.

FIG. 4 is a computer architecture diagram showing an illustrative computer hardware architecture for a computing system capable of implementing the embodiments presented herein.

### DETAILED DESCRIPTION

The following detailed description is directed to determining an optimal width of a buffer that approximates the location of an asset. The asset may be an above-ground asset or a buried asset. For example, gas pipelines may be deployed above-ground or below-ground. For the sake of simplicity, embodiments described herein primarily refer to determining the buffer width for the purpose of protecting buried assets. However, it should be appreciated that these and other embodiments may be similarly utilized for protecting above-ground assets that are also within the buffer area.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

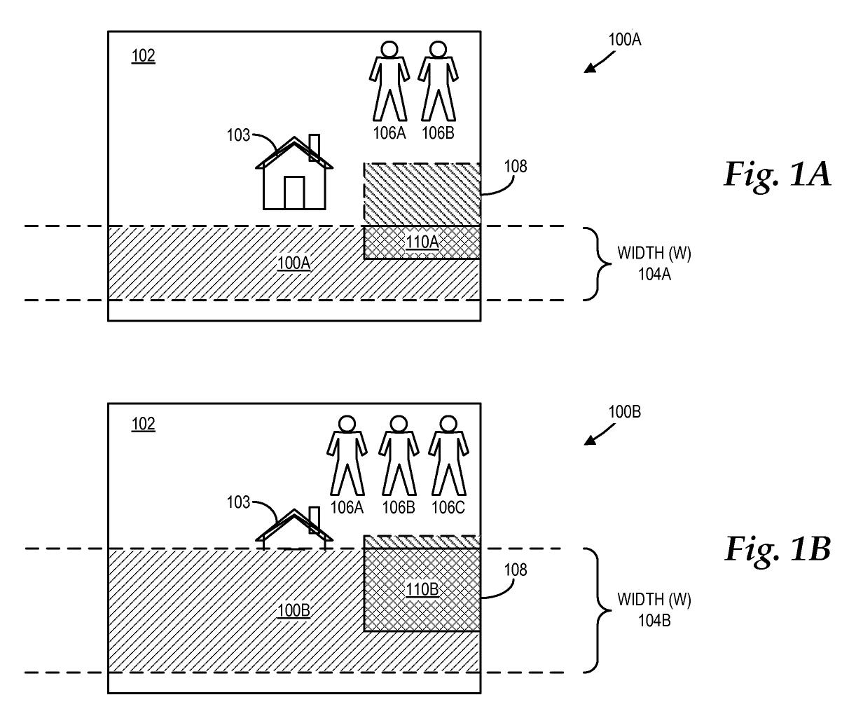

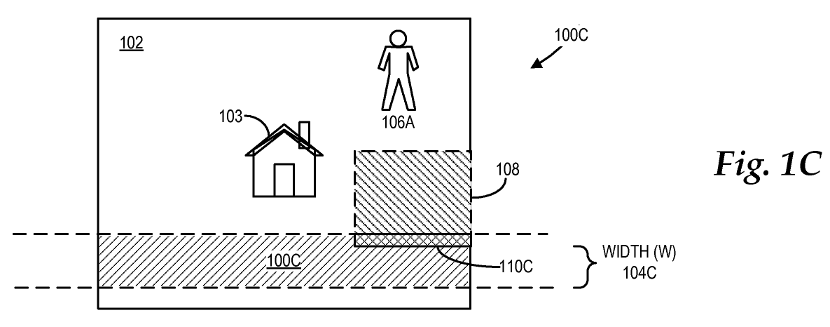

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for determining an optimal width of a buffer that approximates a location of a buried asset will be described. FIG. 1A shows an illustrative implementation of a buffer 100A with respect to a dig area 108. The buffer 100A represents an approximation of a location of a buried asset (not shown) underneath a parcel of land 102, which includes a house 103. The buffer 100A has a first width 104A. The dig area 108 represents a portion of the parcel of land 102 where a dig will be performed. The portion in which the dig area 108 overlaps with the buffer 100A represents a restricted area 110A. As illustrated in FIG. 1A, the buffer 100A includes first diagonal lines in one direction, and the dig area 108 includes second diagonal lines in another direction. The restricted area 110A includes cross-hatching of the first and second diagonal lines representing where the buffer 100A and the dig area 108 overlap.

The restricted area 110A represents a portion of the parcel of land 102 where the dig can potentially damage the buried asset. As such, whenever a service provider is notified of the restricted area 110A, the service provider may take additional steps in order to protect the buried asset. For example, the service provider may dispatch technicians, such as two technicians 106A and 106B, to the parcel of land 102 in order to mark the restricted area 110A and/or to monitor the dig at the restricted area 110A. As illustrated in FIG. 1A, two technicians 106A and 106B are dispatched to the parcel of land 102 based on the size of the restricted area. As described in greater detail below with respect to FIGS. 1B and 1C below, additional technicians may be dispatched when the size of the restricted area is increased, and fewer technicians may be dispatched when the size of the restricted area is decreased.

FIG. 1B shows an illustrative implementation of a buffer 100B with respect to the dig area 108. The buffer 100B represents another approximation of the location of the buried asset underneath the parcel of land 102. The buffer 100B has a second width 104B, which is wider than the first width 104A. The larger width of the second width 104B results in a larger size of the buffer 100B as compared to the buffer 100A. Since the buffer 100B is larger than the buffer 100A, a restricted area 110B where the buffer 100B and the dig area 108 overlap is larger than the restricted area 110A. Due to the larger size of the restricted area 110B in relation to the restricted area 110A, the service provider may dispatch three technicians 106A, 106B, and 106C to the parcel of land 102 in FIG. 1B instead of the two technicians 106A and 106B dispatched to the parcel of land 102 in FIG. 1A.

FIG. 1C shows an illustrative implementation of a buffer 100C with respect to the dig area 108. The buffer 100C represents yet another approximation of the location of the buried asset underneath the parcel of land 102. The buffer 100C has a third width 104C, which is narrower than the first width 104A. The narrower width of the third width 104C results in a smaller size of the buffer 100C as compared to the buffer 100A. Since the buffer 100C is smaller than the buffer 100A, a restricted area 110C where the buffer 100C and the dig area 108 overlap is smaller than the restricted area 110A. Due to the smaller size of the restricted area 110C in relation to the restricted area 110A, the service provider may dispatch one technician 106A to the parcel land 102 in FIG. 1C instead of the two technicians 106A and 106B dispatched to the parcel of land 102 in FIG. 1A.

FIGS. 1A, 1B, and 1C illustrate the significance of predicting the proper size of the buffers 100A, 100B, 100C (collectively referred to as buffers 100). In particular, a larger buffer size, such as the buffer 100B, generally corresponds to an increased number of technicians, such as the technicians 106A, 106B, and 106C, dispatched to the parcel of land 102 as compared with a smaller buffer size, such as the buffer 100C, given the same dig area 108. The service provider that owns or maintains the buried asset may incur significant expense for each additional technician dispatched to the parcel of land 102. Therefore, the service provider may desire a smaller buffer size, which reduces the number of technicians dispatched.

However, a smaller buffer size may increase the risk that a dig will damage the buried asset as compared to a larger buffer size. Once the buried asset is damaged, the service provider may incur significant expenses repairing the buried asset and handling customer service complaints. As result, while the service provider may desire a smaller buffer size to reduce the number of technicians dispatched, the service provider may also desire a buffer size that adequately mitigates the potential for any damage to the buried asset. Embodiments described herein are directed to determining an optimal buffer width that reduces the buffer size while adequately mitigating the potential damage to the buried asset.

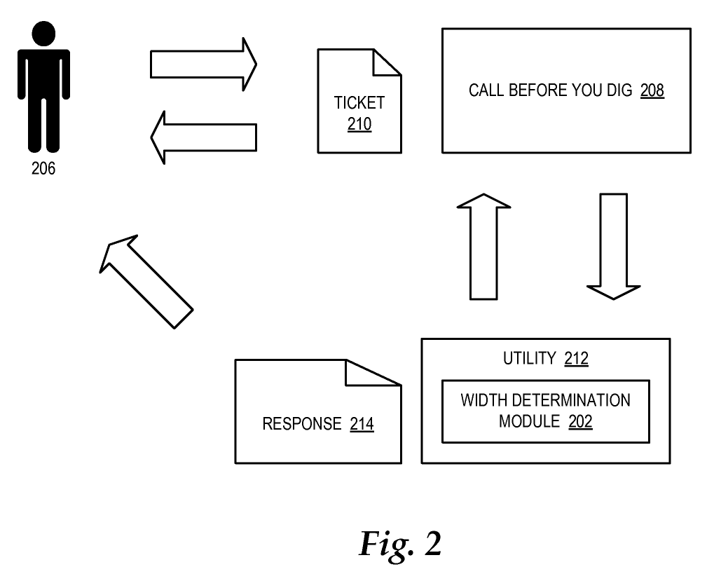

Referring now to FIG. 2, an illustrative implementation of a width determination module 202 operative to determine an optimal buffer width, such as the widths 104A, 104B, and 104C, with respect to a planned dig. The width determination module 202 may be implemented as computer hardware, software, firmware, or combinations thereof. As illustrated in FIG. 2, a caller 206 contacts a utility location service, such as a call before you dig 208, and provides information about a planned dig. The call before you dig 208 then generates a ticket 210 based on the information provided by the caller 206. For example, the ticket 210 may include an identification of the caller, a date that the call was received, a date for the planned dig, and a location of the planned dig. Upon generating the ticket 210, the call before you dig 208 sends the ticket 210 to each service provider, such as a utility 212, that owns or maintains buried assets at or near the location of the planned dig.

Upon receiving the ticket 210, the utility 212 may analyze the ticket 210 to determine whether the planned dig will affect any buried assets that the utility 212 owns or maintains. The utility 212 may then send a response 214 indicating whether the utility 212 will be involved in the planned dig. For example, the response 214 may indicate whether technicians, such as the technicians 106A, 106B, and 106C, will be dispatched to the parcel of land 102. The response 214 may be sent to the call before you dig 208, which forwards the response 214 to the caller 206. Alternatively, the response 214 may be sent directly to the caller 206 without the aid of the utility location service.

According to embodiments, the width determination module 202 determines an optimal buffer width based on the presence of a buried asset at the location of the planned dig specified on the ticket 210. The utility 212 may determine the size of the buffer, such as the buffers 100A, 100B, and 100C, based on the optimal buffer width. Upon determining the size of the buffer, the utility 212 may determine whether a restricted area, such as the restricted areas 110A, 110B, and 110C, is present where the buffer overlaps with the location of the planned dig. If the restricted area is present, then the utility 212 may then determine the number of technicians to be dispatched to the parcel of land 102 according to the size of the restricted area.

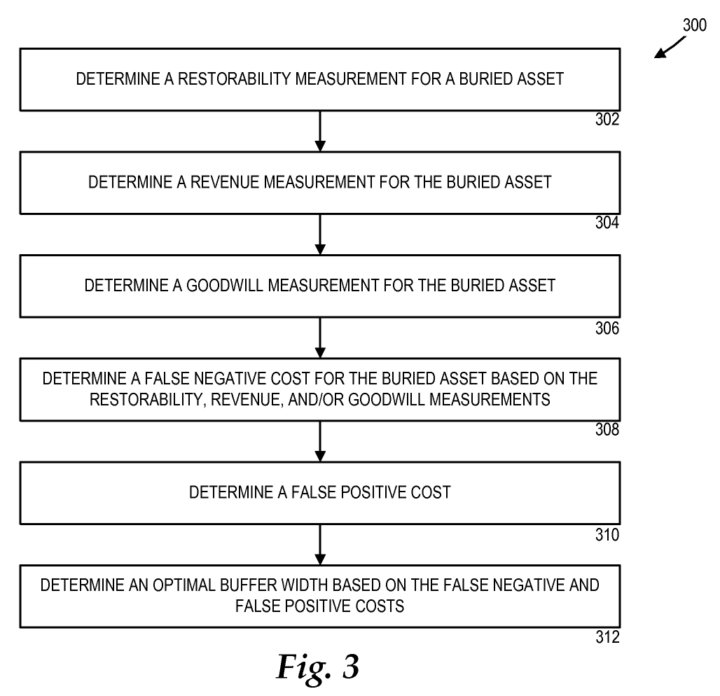

FIG. 3 is a flow diagram illustrating a method 300 for determining an optimal buffer width, such as the widths 104A, 104B, and 104C, in accordance with exemplary embodiments. According to the method 300, the width determination module 202 determines (at 302) a restorability measurement for a buried asset. According to embodiments, the restorability measurement is a measure identifying an ability of a service provider, such as the utility 212, to restore a given service when an associated buried asset becomes damaged. In one embodiment, the restorability measurement is represented in terms of the service (e.g., data, water, gas, etc.) that be diverted around a damaged buried asset. For example, the restorability measurement may indicate the ability of a telephone company to reroute calls around the loss of a telephone line. If the restorability measurement indicates that the telephone line is 100% restorable, then all of the service passing through the buried asset can be rerouted around the buried asset. In contrast, if the restorability measurement indicates that the telephone line is 0% restorable, then none of the service passing through the buried asset can be rerouted around the buried asset.

In a further embodiment, the restorability measurement is represented in terms of the relative amount of revenue lost as a result of the buried asset being damaged. For example, if a given buried asset is 100% restorable, then the buried asset can be damaged without any loss in revenue to the utility 212. In contrast, if the buried asset is 0% restorable, then all revenue from the service provided through the buried asset is lost when the buried asset is damaged. It should be appreciated that the use of percentages to describe the restorability measurement is merely illustrative and that other suitable ways to represent the restorability measurement may be similarly utilized.

In addition to determining the restorability measurement, the width determination module 202 also determines (at 304) a revenue measurement for the buried asset. According to embodiments, the revenue measurement is a measure identifying a value (e.g., a monetary value) of the service provided through a given buried asset. For example, the revenue measurement may indicate the value of the data (e.g., cable television, cable Internet, Internet Protocol Television (“IPTV”), etc.) carried through a cable line. The value of the service provided through the buried asset may provide a measure of the potential revenue lost when the buried asset becomes damaged. If the revenue measurement indicates that the value of the service provided through a given buried asset is relatively lower, then the risk of losing the buried asset is also relatively lower. If the revenue measurement indicates that the value of the service provided through the buried asset is relatively higher, then the risk of losing the buried asset is also relatively higher.

The restorability measurement may also include suitable expenses that result from damage to the buried asset and that further increase the potential revenue lost. Such expenses may include, but are not limited to, lost short-term revenue (e.g., a customer cannot make a long-distance call, a customer cannot purchase a pay-per-view event, etc.), lost long-term revenue (e.g., a customer decides to terminate services from the utility 212), and expenses incurred to fix the damaged buried asset.

It should be appreciated that other logical characteristics of the buried asset for determining the risk of losing the buried asset may be similarly utilized in lieu of or in addition to the revenue measurement and the restorability measurement as previously described. For example, as illustrated in FIG. 3, the width determination module 202 determines (at 306) a goodwill measurement for the buried asset. According to embodiments, the goodwill measurement for the buried asset indicates the amount of customer confidence that is lost when a service cannot be provided as a result of a damaged buried asset. If the goodwill measurement indicates that an insignificant amount of customer confidence is lost as a result of a damaged buried asset, then the risk of losing the buried asset is also relatively lower. If the goodwill measurement indicates that a significant amount of customer confidence is lost as a result of the damaged buried asset, then the risk of losing the buried asset is also relatively higher.

Upon determining the logical characteristics, such as the restorability measurement, the revenue measurement, and the goodwill measurement, of the buried asset, the width determination module 202 determines (at 308) a false negative cost for the buried asset based on the risk measurements. According to embodiments, the false negative cost refers to the cost resulting from the occurrence of a false negative. As used herein, a false negative refers to a ticket, such as the ticket 210, that is improperly judged as not risking damage to buried asset. That is, a false negative refers to a situation where a dig actually damages the buried asset after a service provider, such as the utility 212, determined that the ticket 210 would not affect the buried asset. The occurrence of a false negative may result in, among other costs, the costs to restore the damaged buried asset, a loss of revenue/profit due to the loss of service, and a loss of revenue/profit due to the loss of customer confidence.

In one embodiment, the false negative cost is determined based on the restorability measurement, the revenue measurement, and/or the goodwill measurement. For example, if a restorability measurement indicates that alternate routes are not available when a given buried asset becomes damaged, then the false negative cost may increase. If the restorability measurement indicates that alternate routes are available when the buried asset becomes damaged, then the false negative cost may decrease. If a revenue measurement indicates that a value of the service provided by the buried asset is relatively higher, then the false negative cost may also be relatively higher. If the revenue measurement indicates that the value of the service provided by the buried asset is relatively lower, then the false negative cost may also be relatively lower. If the goodwill measurement indicates that a significant amount of customer confidence is lost when a service cannot be provided as a result of a damaged buried asset, then the false negative cost may be relatively higher. If the goodwill measurement indicates that an insignificant amount of customer confidence is lost when the service cannot be provided as a result of the damaged buried asset, then the false negative cost may be relatively lower.

In addition to determining the false negative cost of the buried asset, the width determination module 202 also determines (at 310) a false positive cost of the buried asset. According to embodiments, the false positive cost refers to the cost resulting from the occurrence of a false positive. As used herein, a false positive refers to a ticket, such as the ticket 210, that is improperly judged as risking damage to the buried asset. That is, a false positive refers to a situation where a dig does not damage the buried asset after a service provider, such as the utility 212, determined that the ticket 210 would affect the buried asset. The occurrence of a false negative may result in, among other costs, the costs to dispatch technicians to the parcel of land 102 in order to mark the location of the buried asset and/or to monitor the dig at or near the location of the buried asset.

False negative costs may be determined based on a suitable maintenance cost function. For example, the maintenance cost function may account for maintenance costs incurred based on the restorability measurement, the revenue measurement, and/or the goodwill measurement. The maintenance cost function may place greater emphasis (e.g., a weight) on certain measurements that incur greater costs over other measurements that incur lower costs. False positive costs may be determined based on a suitable loss expectation function. For example, the loss expectation function may account for financial costs incurred as a result of dispatching technicians to the parcel land 102 and performing other unnecessary tasks as a result of the false positive.

Upon determining the false negative costs and the false positive costs, the width determination module 202 determines (at 312) the optimal buffer width based on the false negative costs and the false positive costs. According to embodiments, the maintenance cost function (also referred to herein as P1) and the loss expectation function (also referred to herein as P2) are continuous functions of the optimal buffer width (also referred to herein as w). For example, a wider buffer width can result in fewer false negatives and a greater number of false positives due to the increased number of technicians dispatched to the parcel of land 102. In contrast, a narrower buffer width can result in a great number of false negatives and fewer false positives due to the decreased number of technicians dispatched to the parcel of land 102. As a result, an optimal buffer width may refer to a buffer width that results in the lowest total cost resulting from the maintenance cost function and the loss expectation function.

Since the maintenance cost function and the loss expectation function are continuous functions of the optimal buffer width, the expressions can be minimized by conventional calculus techniques for finding a root of the first derivative with respect to the buffer width. In one embodiment, the optimal buffer width may be expressed as follows:

$$\frac{d}{d w} [ P 1 ( w ) - P 2 ( w ) ] = 0$$

The root of the first derivative expressed above may be determined by suitable analytical or numerical means. The root yields a value for the width, w, that is optimal for a given buried asset by balancing the maintenance cost function and the loss expectation function. The width is optimal because a wider buffer would increase maintenance costs at a rate faster than the financial costs would decrease. Further, a narrower buffer would increase financial losses at a rate faster than the maintenance costs would decrease.

The optimal buffer width may be re-determined on a regular basis (e.g., nightly, weekly, etc.) so that the optimal buffer width can reflect any changes to the logical characteristics of the buried assets. By regularly re-determining the buffer width, a dynamically optimal buffer can be utilized by the utility 212 in order to resolve tickets, such as the ticket 210, resulting in significant cost savings with respect to the buried asset over a period of time.

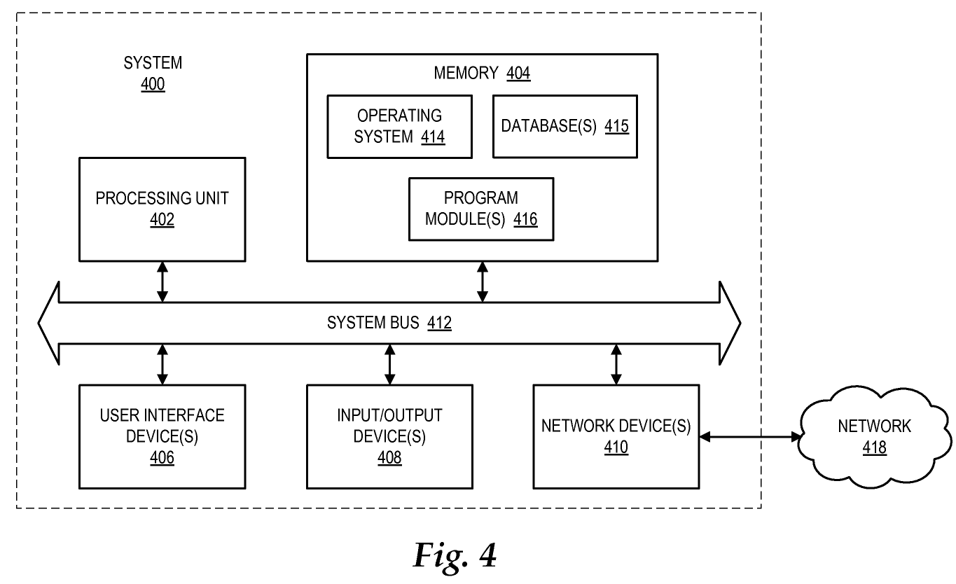

FIG. 4 and the following discussion are intended to provide a brief, general description of a suitable computing environment in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 4 is a block diagram illustrating the system 400 operative to determine an optimum buffer width for a buried asset, in accordance with exemplary embodiments. The system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410. Examples of the system 400 include, but are not limited to, computers, servers, personal digital assistants, cellular phones, or any suitable computing devices.

The processing unit 402 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 404 communicates with the processing unit 402 via the system bus 412. In one embodiment, the memory 404 is operatively connected to a memory controller (not shown) that enables communication with the processing unit 402 via the system bus 412. The memory 404 includes an operating system 414, one or more databases 415, and one or more program modules 416, according to exemplary embodiments. An example of the database may be a GIS-based system storing address data. A database may also be used to store tickets, such as the tickets 210, created by a utility location service, such as the call before you dig 208, and responses, such as the response 214, created by a service provider, such as the utility 212. An example of the program modules 416 may be the width determination module 202. Examples of operating systems, such as the operating system 414, include, but are not limited to, WINDOWS and WINDOWS MOBILE operating systems from MICROSOFT CORPORATION, MAC OS operating system from APPLE CORPORATION, LINUX operating system, SYMBIAN OS from SYMBIAN SOFTWARE LIMITED, BREW from QUALCOMM INCORPORATED, and FREEBSD operating system.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the system 400.

The user interface devices 406 may include one or more devices with which a user accesses the system 400. The user interface devices 406 may include, but are not limited to, computers, servers, personal digital assistants, cellular phones, or any suitable computing devices. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer.

The network devices 410 enable the system 400 to communicate with other networks or remote systems via a network. Examples of network devices 410 may include, but are not limited to, a modem, a radio frequency (“RF”) or infrared (“IR”) transceiver, a telephonic interface, a bridge, a router, or a network card. The network 418 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 418 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for determining an optimum buffer width for an above-ground or buried asset, comprising:
determining a restorability measurement for the asset, the restorability measurement indicating an ability for a technician to restore the asset when the asset becomes damaged;
determining a revenue measurement for the asset, the revenue measurement indicating a value of a service provided through the asset; and
determining the optimum buffer width based on the restorability measurement and the revenue measurement, the optimum buffer width comprising a width of a buffer indicating an approximate location of the asset.

2. The method of claim 1, further comprising determining a goodwill measurement for the asset, the goodwill measurement indicating an amount of customer confidence that is lost when the asset becomes damaged, wherein determining the optimum buffer width based on the restorability measurement and the revenue measurement comprises determining the optimum buffer width based on the restorability measurement, the revenue measurement, and the goodwill measurement.

3. The method of claim 1, wherein determining the optimum buffer width comprises:
determining a false negative cost based on the restorability measurement and the revenue measurement, the false negative cost comprising a cost of a ticket being improperly judged as not risking damage to the asset;
determining a false positive cost, the false positive cost comprising a cost of a ticket being improperly judged as risking damage asset; and
determining the optimum buffer width based on the false negative cost and the false positive cost.

4. The method of claim 3, wherein the optimum buffer width balances maintenance costs to repair damage to the asset resulting from the false negative cost and financial costs to dispatch unnecessary technicians resulting from the false positive cost; wherein an increase to the optimum buffer width causes the maintenance costs to increase at a rate faster than the financial costs decrease; and wherein a decrease to the optimum buffer width causes the financial costs to increase at a rate faster than the maintenance costs decrease.

5. The method of claim 1, further comprising:
determining a dig location, the dig location indicating a location of a dig;
identifying whether a restricted area is present where the dig location overlaps with the buffer; and
upon determining that the restricted area is present, dispatching technicians to the restricted area according to a size of the restricted area.

6. The method of claim 1, wherein the restorability measurement comprises an availability of alternate routes for re-routing service around the asset when the asset becomes damaged.

7. The method of claim 1, further comprising re-determining the optimum buffer width to reflect changes to the restorability measurement or the revenue measurement.

8. A system for determining an optimum buffer width for an above-ground or buried asset, comprising:
a memory for storing a program containing code for determining the optimum buffer width for the asset;
a processor functionally coupled to the memory, the processor being responsive to computer-executable instructions contained in the program and operative to:
determine a restorability measurement for the asset, the restorability measurement indicating an ability for a technician to restore the asset when the asset becomes damaged,
determine a revenue measurement for the asset, the revenue measurement indicating a value of a service provided through the asset, and
determine the optimum buffer width based on the restorability measurement and the revenue measurement, the optimum buffer width comprising a width of a buffer indicating an approximate location of the asset.

9. The system of claim 8, the processor being responsive to further computer-executable instructions contained in the program and operative to determine a goodwill measurement for the asset, the goodwill measurement indicating an amount of customer confidence that is lost when the asset becomes damaged, wherein to determine the optimum buffer width based on the restorability measurement and the revenue measurement, the processor is further operative to determine the optimum buffer width based on the restorability measurement, the revenue measurement, and the goodwill measurement.

10. The system of claim 8, wherein to determine the optimum buffer width, the processor is further operative to:
determine a false negative cost based on the restorability measurement and the revenue measurement, the false negative cost comprising a cost of a ticket being improperly judged as not risking damage to the asset,
determine a false positive cost, the false positive cost comprising a cost of a ticket being improperly judged as risking damage asset, and
determine the optimum buffer width based on the false negative cost and the false positive cost.

11. The system of claim 10, wherein the optimum buffer width balances maintenance costs to repair damage to the asset resulting from the false negative cost and financial costs to dispatch unnecessary technicians resulting from the false positive cost, wherein an increase to the optimum buffer width causes the maintenance costs to increase at a rate faster than the financial costs decrease, and wherein a decrease to the optimum buffer width causes the financial costs to increase at a rate faster than the maintenance costs decrease.

12. The system of claim 8, the processor being responsive to further computer-executable instructions contained in the program and operative to:
determine a dig location, the dig location indicating a location of a dig,
identify whether a restricted area is present where the dig location overlaps with the buffer, and
upon determining that the restricted area is present, dispatch technicians to the restricted area according to a size of the restricted area.

13. The system of claim 8, wherein the restorability measurement comprises an availability of alternate routes for re-routing service around the asset when the asset becomes damaged.

14. A computer-readable medium having instructions stored thereon for execution by a processor to provide a method for determining an optimum buffer width for an above-ground or buried asset, the method comprising:
determining a restorability measurement for the asset, the restorability measurement indicating an ability for a technician to restore the asset when the asset becomes damaged;
determining a revenue measurement for the asset, the revenue measurement indicating a value of a service provided through the asset; and
determining the optimum buffer width based on the restorability measurement and the revenue measurement, the optimum buffer width comprising a width of a buffer indicating an approximate location of the asset.

15. The computer-readable medium of claim 14, the method further comprising determining a goodwill measurement for the asset, the goodwill measurement indicating an amount of customer confidence that is lost when the asset becomes damaged, wherein determining the optimum buffer width based on the restorability measurement and the revenue measurement comprises determining the optimum buffer width based on the restorability measurement, the revenue measurement, and the goodwill measurement.

16. The computer-readable medium of claim 14, wherein determining the optimum buffer width comprises:
determining a false negative cost based on the restorability measurement and the revenue measurement, the false negative cost comprising a cost of a ticket being improperly judged as not risking damage to the asset;
determining a false positive cost, the false positive cost comprising a cost of a ticket being improperly judged as risking damage asset; and
determining the optimum buffer width based on the false negative cost and the false positive cost.

17. The computer-readable medium of claim 16, wherein the optimum buffer width balances maintenance costs to repair damage to the asset resulting from the false negative cost and financial costs to dispatch unnecessary technicians resulting from the false positive cost; wherein an increase to the optimum buffer width causes the maintenance costs to increase at a rate faster than the financial costs decrease; and wherein a decrease to the optimum buffer width causes the financial costs to increase at a rate faster than the maintenance costs decrease.

18. The computer-readable medium of claim 14, the method further comprising:
determining a dig location, the dig location indicating a location of a dig;
identifying whether a restricted area is present where the dig location overlaps with the buffer; and
upon determining that the restricted area is present, dispatching technicians to the restricted area according to a size of the restricted area.

19. The computer-readable medium of claim 14, wherein the restorability measurement comprises an availability of alternate routes for re-routing service around the asset when the asset becomes damaged.

20. The computer-readable medium of claim 14, the method further comprising re-determining the optimum buffer width to reflect changes to the restorability measurement or the revenue measurement.
